(19) United States
(12) Patent Application Publication
(10) Pub. No.: US 2014/0171354 A1
(43) Pub. Date: Jun. 19, 2014

(54) DETERGENT COMPOSITION CONTAINING AN AMPS COPOLYMER AND A MALEIC ACID POLYMER

(71) Applicant: ECOLAB USA INC., St. Paul, MN (US)

(72) Inventors: Altony Miralles, Woodbury, MN (US); Michelle Fung, Eden Prairie, MN (US); John Krueger, Rosemount, MN (US)

(73) Assignee: ECOLAB USA INC., St. Paul, MN (US)

(21) Appl. No.: 14/184,134

(22) Filed: Feb. 19, 2014

Related U.S. Application Data
(63) Continuation-in-part of application No. 13/223,467, filed on Sep. 1, 2011.
Application No. 13/223,467 is a continuation-in-part of application No. 12/288,355, filed on Oct. 17, 2008.
(60) Provisional application No. 60/980,912, filed on Oct. 18, 2007.

(51) Int. Cl. C11D 3/00

(52) U.S. Cl. CPC C11D 3/0036
USPC 510/400; 8/137; 134/25.2

(57) ABSTRACT

Detergent compositions including at least one AMPS copolymer, at least one maleic acid polymer, an alkaline agent and optional additives are disclosed. Embodiments of the present invention are phosphorus free, and exhibit reduced scale accumulation for warewashing applications. Solid embodiments of the present invention may be disintegrant free.

### RELATED APPLICATIONS

This application is a continuation-in-part of U.S. patent application Ser. No. 13/223,467, filed Sep. 1, 2011, the entire disclosure of which is incorporated herein by reference in its entirety for all purposes.

### TECHNICAL FIELD

The present invention is related to the field of alkaline detergent compositions. In particular, the present invention is related to phosphorus-free alkaline detergent compositions including a copolymer of 2-Acrylamido-2-methylpropane sulfonic acid (AMPS), a maleic acid polymer and an optional complexing agent.

### BACKGROUND

As the use of phosphorus raw materials in detergents has become more regulated, the warewashing and laundry industries have sought new avenues for providing high washing capability while controlling scale accumulation in washing machines and on objects to be cleaned. Alkaline detergents, while being effective for cleaning may result in heavy scale formation that is difficult to control. Water hardness also impacts scale formation, with water hardness of 17 grain or higher presenting particular challenges. Certain polymers have been added to reduce scale accumulation, but have either been found to reduce cleaning effectiveness or require a very high concentration when used with hard water.

### SUMMARY

One embodiment of the present invention provides a detergent composition including at least one copolymer comprising 2-Acrylamido-2-methylpropane sulfonic acid (AMPS) or derivatives thereof, at least one maleic acid polymer and at least one alkaline source. The detergent composition may further include at least one weak complexing agent and may be free of phosphorus.

Another embodiment is a use solution including the AMPS copolymer, the maleic acid polymer, the optional weak complexing agent, the alkaline source and water. A further embodiment is a method of preventing scale in an automatic washing machine, in which a detergent composition including the components disclosed herein are dispensed into a washing machine. The washing machine may be an automatic ware washing or a textile washing machine. In a solid embodiment of the invention, compositions thereof are free of disintegrants.

### DETAILED DESCRIPTION

The detergent compositions of the present invention include at least one 2-Acrylamido-2-methylpropane sulfonic acid (AMPS) copolymer, at least one maleic acid polymer and at least one alkaline source. The detergent composition may optionally include at least one weak complexing agent. The compositions may be used for machine and manual warewashing, presoaks, laundry and textile cleaning and destaining, carpet cleaning and destaining, vehicle cleaning and care applications, surface cleaning and destaining, kitchen and bath cleaning and destaining, floor cleaning and destaining, cleaning in place operations, general purpose cleaning and destaining, industrial or household cleaners, and pest control agents. The composition may be in the form of a liquid concentrate, a use solution, a solid block, granules or a powder.

In one embodiment, the AMPS copolymer used in the detergent composition is a copolymer of AMPS and a carboxylic acid. Suitable carboxylic acids for use in the copolymer include acrylic acid, methacrylic acid and maleic acid. Copolymers of acrylic acid/AMPS may be particularly suitable for use in embodiments of the present invention. Commercially available examples of such copolymers include Aquatreat AR 545 available from Alco Chemical, Sokalan CP-50 available from BASF and Acumer 2000 available from Dow Chemical. In one embodiment, the detergent composition in concentrated form includes at least about 1.0 wt % of the AMPS copolymer, more particularly, between about 1.0 and 25.0 wt % AMPS copolymer, even more particularly, between about 3.0 and 10.0 wt % AMPS copolymer, and even more particularly, between about 4.0 wt/% and about 8.0 wt % AMPS copolymer.

The maleic acid polymer included in embodiments of the present invention may include homopolymers and copolymers of maleic acid. In one embodiment, the maleic acid polymer has a molecular weight of between about 500 and about 5,000 g/mol. Examples of suitable maleic acid polymers include Aquatreat AR-801 available from Alco Chemical, Chattanooga, Tenn., Optidose 4210 available from Dow and Belclene 200 available from Houghton Chemical Corporation.

In another embodiment, the maleic acid polymer is a maleic/methylvinyl ether copolymer, which may have a molecular weight of between about 125,000 g/mol and about 800,000 g/mol, and/or a polydispersity index of between about 2 and 6. The maleic and methylvinyl ether monomer segments may be randomly arranged in one embodiment and/or have alternating segments such that the resulting maleic/methylvinyl ether copolymer has the following general structure:

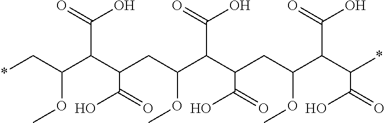 [SMILES: *CC(OC)C(C(=O)O)C(CC(OC)C(C(=O)O)C(CC(OC)C(C(=O)O)C(*)C(=O)O)C(=O)O)C(=O)O]

Examples of suitable maleic/methylvinyl ether copolymers are commercially available from ISP under the tradename “Gantrez,” as well as other suppliers such as SigmaAldrich. Mixtures of maleic acid polymers and maleic/methylvinyl ether copolymers may also be employed.

In one embodiment, the detergent composition in concentrated form includes at least about 1.0 wt % maleic acid polymer, more particularly, between about 1.0 and 25.0 wt % maleic acid polymer, even more particularly, between about 3.0 and 10.0 wt % maleic acid polymer, and even more particularly, between about 4.0 wt/% and about 8.0 wt % maleic acid polymer.

The optional weak complexing agent acid may bind to metal in use to form a metal complex. Suitable weak complexing agents may have a pKf (logarithm of the equilibrium constant of formation) from about 0.0 to about 12.0, more particularly, from about 1.0 to about 6.0. Examples of suitable weak complexing agents comprise acids and acid salts including citric acid and citric acid salts such as sodium citrate, tartaric acid and tartaric acid salts such as sodium tartrate, methylglycinediacetic acid and methylglycinediacetic acid salts such as trisodium methylglycinediacetic acid, maleic acid and its salts, ethylenediaminetetraacetic acid and its salts, 1-glutamic acid and its salts, N,N-diacetic acid and salts such as N,N-diacetic acid disodium salt, glucaric acid and its salts, saccharic and lactic acid and their salts. Tartaric acid, citric acid and their salts may be particularly suitable for embodiments of the present invention with citric acid and its salts being particularly suitable. Additional complexing agents that may be suitable include glucose, curcumin and catechol.

Embodiments of the present invention that utilize a weak complexing agent may include at least about 1.0 wt % complexing agent, more particularly, at least about 3.0 wt % complexing agent. Other embodiments may include from about 1.0 wt % to about 25.0 wt % complexing agent, more particularly, from about 1.0 wt % to about 15.0 wt %, and more particularly, from about 3.0 wt % to about 10 wt % complexing agent.

The detergent composition may further include an effective amount of one or more alkaline sources to enhance cleaning and improve soil removal performance. In general, it is expected that a concentrated detergent composition will include the alkaline source in an amount of at least about 5% by weight, at least about 10% by weight, at least about 15% by weight, or at least about 25% by weight. In order to provide sufficient room for other components in the concentrate, the alkaline source can be provided in the concentrate in an amount of less than about 75% by weight, less than about 60% by weight, or less than about 50% by weight. In another embodiment, the alkalinity source may constitute between about 0.1% and about 90% by weight, between about 0.5% and about 80% by weight, and between about 1% and about 60% by weight of the total weight of the detergent composition.

In one embodiment sufficient alkaline agent should be added to provide a use composition having a pH of at least about 9. When the use composition has a pH of between about 8 and about 10, it can be considered mildly alkaline, and when the pH is greater than about 12, the use composition can be considered caustic.

Examples of suitable alkaline sources of the detergent composition include, but are not limited to alkali metal carbonates and alkali metal hydroxides. Exemplary alkali metal carbonates that can be used include, but are not limited to: sodium or potassium carbonate, bicarbonate, sesquicarbonate, and mixtures thereof. Exemplary alkali metal hydroxides that can be used include, but are not limited to sodium, lithium, or potassium hydroxide. The alkali metal hydroxide may be added to the composition in any form known in the art, including as solid beads, dissolved in an aqueous solution, or a combination thereof. Alkali metal hydroxides are commercially available as a solid in the form of prilled solids or beads having a mix of particle sizes ranging from about 12-100 U.S. mesh, or as an aqueous solution, as for example, as a 45% and a 50% by weight solution. In one embodiment, the alkali metal hydroxide is added in the form of an aqueous solution, particularly a 50% by weight hydroxide solution, to reduce the amount of heat generated in the composition due to hydration of the solid alkali material.

In addition to the first alkalinity source, the detergent composition may comprise a secondary alkalinity source. Examples of useful secondary alkaline sources include, but are not limited to: metal silicates such as sodium or potassium silicate or metasilicate; metal carbonates such as sodium or potassium carbonate, bicarbonate, sesquicarbonate; metal borates such as sodium or potassium borate; and ethanolamines and amines. Such alkalinity agents are commonly available in either aqueous or powdered form, either of which is useful in formulating the present detergent compositions.

The detergent composition may be phosphorus-free and/or nitrilotriacetic acid (NTA)-free to meet certain regulations. Phosphorus-free (also referred to as “free of phosphorus”) means a concentrated composition having less than approximately 0.5 wt %, more particularly, less than approximately 0.1 wt %, and even more particularly less than approximately 0.01 wt % phosphorous based on the total weight of the concentrated composition. NTA-free (also referred to as “free of NTA”) means a concentrated composition having less than approximately 0.5 wt %, less than approximately 0.1 wt %, and often less than approximately 0.01 wt % NTA based on the total weight of the concentrated composition.

Water may be independently added to the detergent composition or may be provided as a result of its presence in an aqueous material that is added to the detergent composition. For example, materials added to the detergent composition may include water or may be prepared in an aqueous premix available for reaction with the detergent component(s). For solid blocks, water may be introduced to provide a desired viscosity for processing prior to solidification and to provide a desired rate of solidification. The water may also be present as a processing aid and may be removed or become water of hydration. The water may thus be present in the form of aqueous solutions of the detergent composition. The water may be provided as deionized water or as softened water.

The amount of water in the resulting detergent composition will depend on the form of the composition (solid or liquid). For solid compositions, the amount of water may vary depending on whether the solid detergent composition is processed through forming techniques or casting (solidification occurring within a container) techniques. In general, when the components are processed by forming techniques, the solid detergent composition may include a smaller amount of water for solidification compared with the casting techniques. When preparing the solid detergent composition by forming techniques, water may be present in ranges of between about 5% and about 25% by weight, particularly between about 7% and about 20% by weight, and more particularly between about 8% and about 15% by weight. When preparing the solid detergent composition by casting techniques, water may be present in the ranges of between about 15% and about 50% by weight, particularly between about 20% and about 45% by weight, and more particularly between about 22% and about 40% by weight.

### Additional Functional Materials

In some embodiments, the detergent composition comprises, consists of or consists essentially of the AMPS copolymer, maleic acid polymer, optional weak complexing agent and alkaline source, and includes no additional functional materials or amounts and types of functional materials that do not materially impact the scale prevention properties of the detergent composition. In these embodiments, the component concentrations ranges provided above for the detergent composition may be representative of the ranges of those same components in the detergent composition. Representative component ranges for the concentrated detergent composition (with or without additional functional materials) are set forth in Table 1.

TABLE 1

| | Embodiment | Embodiment | Embodiment |
|---|---|---|---|
| Material | #1 | #2 | #3 |
| AMPS copolymer | 1.0-25.0 wt % | 3.0-10.0 wt % | 4.0-8.0 wt % |
| Maleic acid | 1.0-25.0 wt % | 3.0-10.0 wt % | 4.0-8.0 wt % |
| polymer | | | |
| Sodium | 0.1-90.0 wt % | 0.5-80.0 wt % | 1.0 wt %-60.0 wt % |
| Hydroxide | | | |
| Weak | 1.0-25.0 wt % | 1.0-15.0 wt % | 3.0-10.0 wt % |
| Complexing | | | |
| Agent | | | |

In other embodiments, the components of the detergent composition can be combined with material amounts of various additional functional components.

The functional materials provide desired properties and functionalities to the detergent composition. For the purpose of this application, the term “functional materials” includes a material that when dispersed or dissolved in a use and/or concentrate, such as an aqueous solution, provides a beneficial property in a particular use. Some particular examples of functional materials are discussed in more detail below, although the particular materials discussed are given by way of example only, and that a broad variety of other functional materials may be used. For example, many of the functional materials discussed below relate to materials used in cleaning and/or destaining applications. However, other embodiments may include functional materials for use in other applications.

### Surfactants

The detergent composition can include at least one cleaning agent comprising a surfactant or surfactant system. A variety of surfactants can be used in the detergent composition, including, but not limited to: anionic, nonionic, cationic, and zwitterionic surfactants. Surfactants are an optional component of the detergent composition and can be excluded from the concentrate. Exemplary surfactants that can be used are commercially available from a number of sources. For a discussion of surfactants, see Kirk-Othmer, Encyclopedia of Chemical Technology, Third Edition, volume 8, pages 900-912. When the detergent composition includes a cleaning agent, the cleaning agent is provided in an amount effective to provide a desired level of cleaning. The detergent composition, when provided as a concentrate, can include the cleaning agent in a range of about 0.05% to about 20% by weight, about 0.5% to about 15% by weight, about 1% to about 15% by weight, about 1.5% to about 10% by weight, and about 2% to about 8% by weight. Additional exemplary ranges of surfactant in a concentrate include about 0.5% to about 8% by weight, and about 1% to about 5% by weight.

Examples of anionic surfactants useful in the detergent composition include, but are not limited to: carboxylates such as alkylcarboxylates and polyalkoxycarboxylates, alcohol ethoxylate carboxylates, nonylphenol ethoxylate carboxylates; sulfonates such as alkylsulfonates, alkylbenzenesulfonates, alkylarylsulfonates, sulfonated fatty acid esters; sulfates such as sulfated alcohols, sulfated alcohol ethoxylates, sulfated alkylphenols, alkylsulfates, sulfosuccinates, and alkylether sulfates. Exemplary anionic surfactants include, but are not limited to: sodium alkylarylsulfonate, alpha-olefinsulfonate, and fatty alcohol sulfates.

Examples of nonionic surfactants useful in the detergent composition include, but are not limited to, those having a polyalkylene oxide polymer as a portion of the surfactant molecule. Such nonionic surfactants include, but are not limited to: chlorine-, benzyl-, methyl-, ethyl-, propyl-, butyl- and other like alkyl-capped polyethylene glycol ethers of fatty alcohols; polyalkylene oxide free nonionics such as alkyl polyglycosides; sorbitan and sucrose esters and their ethoxylates; alkoxylated amines such as alkoxylated ethylene diamine; alcohol alkoxylates such as alcohol ethoxylate propoxylates, alcohol propoxylates, alcohol propoxylate ethoxylate propoxylates, alcohol ethoxylate butoxylates; nonylphenol ethoxylate, polyoxyethylene glycol ether; carboxylic acid esters such as glycerol esters, polyoxyethylene esters, ethoxylated and glycol esters of fatty acids; carboxylic amides such as diethanolamine condensates, monoalkanolamine condensates, polyoxyethylene fatty acid amides; and polyalkylene oxide block copolymers. An example of a commercially available ethylene oxide/propylene oxide block copolymer includes, but is not limited to, PLURONIC®, available from BASF Corporation, Florham Park, N.J. An example of a commercially available silicone surfactant includes, but is not limited to, ABIL® B8852, available from Goldschmidt Chemical Corporation, Hopewell, Va.

Examples of cationic surfactants that can be used in the detergent composition include, but are not limited to: amines such as primary, secondary and tertiary monoamines with C18 alkyl or alkenyl chains, ethoxylated alkylamines, alkoxylates of ethylenediamine, imidazoles such as a 1-(2-hydroxyethyl)-2-imidazoline, a 2-alkyl-1-(2-hydroxyethyl)-2-imidazoline, and the like; and quaternary ammonium salts, as for example, alkylquaternary ammonium chloride surfactants such as n-alkyl(C12-C18)dimethylbenzyl ammonium chloride, n-tetradecyldimethylbenzylammonium chloride monohydrate, and a naphthylene-substituted quaternary ammonium chloride such as dimethyl-1-naphthylmethylammonium chloride. The cationic surfactant can be used to provide sanitizing properties.

Examples of zwitterionic surfactants that can be used in the detergent composition include, but are not limited to: betaines, imidazolines, and propionates.

Because the detergent composition is intended to be used in an automatic dishwashing or warewashing machine, the surfactants selected, if any surfactant is used, can be those that provide an acceptable level of foaming when used inside a dishwashing or warewashing machine. Detergent compositions for use in automatic dishwashing or warewashing machines are generally considered to be low-foaming compositions. Low foaming surfactants that provide the desired level of detersive activity are advantageous in an environment such as a dishwashing machine where the presence of large amounts of foaming can be problematic. In addition to selecting low foaming surfactants, defoaming agents can also be utilized to reduce the generation of foam. Accordingly, surfactants that are considered low foaming surfactants can be used. In addition, other surfactants can be used in conjunction with a defoaming agent to control the level of foaming.

### Builders or Water Conditioners

The detergent composition can include one or more building agents, also called chelating or sequestering agents (e.g., builders), including, but not limited to: a condensed phosphate, a phosphonate, an aminocarboxylic acid, or a polyacrylate. In general, a chelating agent is a molecule capable of coordinating (i.e., binding) the metal ions commonly found in natural water to prevent the metal ions from interfering with the action of the other detersive ingredients of a cleaning composition. Preferable levels of addition for builders that can also be chelating or sequestering agents are between about 0.1% to about 70% by weight, about 1% to about 60% by weight, or about 1.5% to about 50% by weight. If the detergent is provided as a concentrate, the concentrate can include between approximately 1% to approximately 60% by weight, between approximately 3% to approximately 50% by weight, and between approximately 6% to approximately 45% by weight of the builders. Additional ranges of the builders include between approximately 3% to approximately 20% by weight, between approximately 6% to approximately 15% by weight, between approximately 25% to approximately 50% by weight, and between approximately 35% to approximately 45% by weight.

Examples of condensed phosphates include, but are not limited to: sodium and potassium orthophosphate, sodium and potassium pyrophosphate, sodium tripolyphosphate, and sodium hexametaphosphate. A condensed phosphate may also assist, to a limited extent, in solidification of the detergent composition by fixing the free water present in the composition as water of hydration.

Examples of phosphonates included, but are not limited to: 1-hydroxyethane-1,1-diphosphonic acid, CH2C(OH)[PO(OH)2]2; aminotri(methylenephosphonic acid), N[CH2PO(OH)2]3; aminotri(methylenephosphonate), sodium salt (ATMP), N[CH2PO(ONa)2]3; 2-hydroxyethyliminobis(methylenephosphonic acid), HOCH2CH2N[CH2PO(OH)2]2; diethylenetriaminepenta(methylenephosphonic acid), (HO)2POCH2N[CH2CH2N[CH2PO(OH)2]2]2; diethylenetriaminepenta(methylenephosphonate), sodium salt (DTPMP), C9H(28-x)N3NaxO15P5 (x=7); hexamethylenediamine(tetramethylenephosphonate), potassium salt, C10H(28-x)N2KxO12P4 (x=6); bis(hexamethylene)triamine(pentamethylenephosphonic acid), (HO2)POCH2N[(CH2)2N[CH2PO(OH)2]2]2; and phosphorus acid, H3PO3. A preferred phosphonate combination is ATMP and DTPMP. A neutralized or alkaline phosphonate, or a combination of the phosphonate with an alkali source prior to being added into the mixture such that there is little or no heat or gas generated by a neutralization reaction when the phosphonate is added is preferred.

The detergent compositions can contain a non-phosphorus based builder. Although various components may include trace amounts of phosphorus, carboxylates such as citrate, tartrate or gluconate are also suitable. Useful aminocarboxylic acid materials containing little or no NTA include, but are not limited to: N-hydroxyethylaminodiacetic acid, ethylenediaminetetraacetic acid (EDTA), hydroxyethylenediaminetetraacetic acid, diethylenetriaminepentaacetic acid, N-hydroxyethyl-ethylenediaminetriacetic acid (HEDTA), diethylenetriaminepentaacetic acid (DTPA), and other similar acids having an amino group with a carboxylic acid substituent.

Water conditioning polymers can be used as non-phosphorus containing builders. Exemplary water conditioning polymers include, but are not limited to: polycarboxylates. Exemplary polycarboxylates that can be used as builders and/or water conditioning polymers include, but are not limited to: those having pendant carboxylate (—CO2-) groups such as polyacrylic acid, maleic acid, maleic/olefin copolymer, sulfonated copolymer or terpolymer, acrylic/maleic copolymer, polymethacrylic acid, acrylic acid-methacrylic acid copolymers, hydrolyzed polyacrylamide, hydrolyzed polymethacrylamide, hydrolyzed polyamide-methacrylamide copolymers, hydrolyzed polyacrylonitrile, hydrolyzed polymethacrylonitrile, and hydrolyzed acrylonitrile-methacrylonitrile copolymers. For a further discussion of chelating agents/sequestrants, see Kirk-Othmer, Encyclopedia of Chemical Technology, Third Edition, volume 5, pages 339-366 and volume 23, pages 319-320, the disclosure of which is incorporated by reference herein. These materials may also be used at substoichiometric levels to function as crystal modifiers.

### Hardening Agents

The detergent compositions can also include a hardening agent in addition to, or in the form of, the builder. A hardening agent is a compound or system of compounds, organic or inorganic, which significantly contributes to the uniform solidification of the composition. Preferably, the hardening agents are compatible with the cleaning agent and other active ingredients of the composition and are capable of providing an effective amount of hardness and/or aqueous solubility to the processed composition. The hardening agents should also be capable of forming a homogeneous matrix with the cleaning agent and other ingredients when mixed and solidified to provide a uniform dissolution of the cleaning agent from the solid detergent composition during use.

The amount of hardening agent included in the detergent composition will vary according to factors including, but not limited to: the type of detergent composition being prepared, the ingredients of the detergent composition, the intended use of the composition, the quantity of dispensing solution applied to the solid composition over time during use, the temperature of the dispensing solution, the hardness of the dispensing solution, the physical size of the solid detergent composition, the concentration of the other ingredients, and the concentration of the cleaning agent in the composition. It is preferred that the amount of the hardening agent included in the solid detergent composition is effective to combine with the cleaning agent and other ingredients of the composition to form a homogeneous mixture under continuous mixing conditions and a temperature at or below the melting temperature of the hardening agent.

It is also preferred that the hardening agent form a matrix with the cleaning agent and other ingredients which will harden to a solid form under ambient temperatures of approximately 30° C. to approximately 50° C., particularly approximately 35° C. to approximately 45° C., after mixing ceases and the mixture is dispensed from the mixing system, within approximately 1 minute to approximately 3 hours, particularly approximately 2 minutes to approximately 2 hours, and particularly approximately 5 minutes to approximately 1 hour. A minimal amount of heat from an external source may be applied to the mixture to facilitate processing of the mixture. It is preferred that the amount of the hardening agent included in the solid detergent composition is effective to provide a desired hardness and desired rate of controlled solubility of the processed composition when placed in an aqueous medium to achieve a desired rate of dispensing the cleaning agent from the solidified composition during use.

The hardening agent may be an organic or an inorganic hardening agent. A preferred organic hardening agent is a polyethylene glycol (PEG) compound. The solidification rate of solid detergent compositions comprising a polyethylene glycol hardening agent will vary, at least in part, according to the amount and the molecular weight of the polyethylene glycol added to the composition. Examples of suitable polyethylene glycols include, but are not limited to: solid polyethylene glycols of the general formula H(OCH2CH2)nOH, where n is greater than 15, particularly approximately 30 to approximately 1700. Typically, the polyethylene glycol is a solid in the form of a free-flowing powder or flakes, having a molecular weight of approximately 1,000 to approximately 100,000, particularly having a molecular weight of at least approximately 1,450 to approximately 20,000, more particularly between approximately 1,450 to approximately 8,000. The polyethylene glycol is present at a concentration of from approximately 1% to 75% by weight and particularly approximately 3% to approximately 15% by weight. Suitable polyethylene glycol compounds include, but are not limited to: PEG 4000, PEG 1450, and PEG 8000 among others, with PEG 4000 and PEG 8000 being most preferred. An example of a commercially available solid polyethylene glycol includes, but is not limited to: CARBOWAX, available from Union Carbide Corporation, Houston, Tex.

Preferred inorganic hardening agents are hydratable inorganic salts, including, but not limited to: sulfates and bicarbonates. The inorganic hardening agents are present at concentrations of up to approximately 50% by weight, particularly approximately 5% to approximately 25% by weight, and more particularly approximately 5% to approximately 15% by weight.

Urea particles can also be employed as hardeners in the detergent compositions. The solidification rate of the compositions will vary, at least in part, to factors including, but not limited to: the amount, the particle size, and the shape of the urea added to the composition. For example, a particulate form of urea can be combined with a cleaning agent and other ingredients, and preferably a minor but effective amount of water. The amount and particle size of the urea is effective to combine with the cleaning agent and other ingredients to form a homogeneous mixture without the application of heat from an external source to melt the urea and other ingredients to a molten stage. It is preferred that the amount of urea included in the solid detergent composition is effective to provide a desired hardness and desired rate of solubility of the composition when placed in an aqueous medium to achieve a desired rate of dispensing the cleaning agent from the solidified composition during use. In some embodiments, the composition includes between approximately 5% to approximately 90% by weight urea, particularly between approximately 8% and approximately 40% by weight urea, and more particularly between approximately 10% and approximately 30% by weight urea.

The urea may be in the form of prilled beads or powder. Prilled urea is generally available from commercial sources as a mixture of particle sizes ranging from about 8-15 U.S. mesh, as for example, from Arcadian Sohio Company, Nitrogen Chemicals Division. A prilled form of urea is preferably milled to reduce the particle size to about 50 U.S. mesh to about 125 U.S. mesh, particularly about 75-100 U.S. mesh, preferably using a wet mill such as a single or twin-screw extruder, a Teledyne mixer, a Ross emulsifier, and the like.

### Bleaching Agents

Bleaching agents suitable for use in the detergent composition for lightening or whitening a substrate include bleaching compounds capable of liberating an active halogen species, such as Cl2, Br2, —OCl— and/or —OBr—, under conditions typically encountered during the cleansing process. Suitable bleaching agents for use in the detergent compositions include, but are not limited to: chlorine-containing compounds such as chlorines, hypochlorites, or chloramines. Exemplary halogen-releasing compounds include, but are not limited to: the alkali metal dichloroisocyanurates, chlorinated trisodium phosphate, the alkali metal hypochlorites, monochloramine, and dichloramine. Encapsulated chlorine sources may also be used to enhance the stability of the chlorine source in the composition (see, for example, U.S. Pat. Nos. 4,618,914 and 4,830,773, the disclosure of which is incorporated by reference herein). A bleaching agent may also be a peroxygen or active oxygen source such as hydrogen peroxide, perborates, sodium carbonate peroxyhydrate, potassium permonosulfate, and sodium perborate mono and tetrahydrate, with and without activators such as tetraacetylethylene diamine. When the concentrate includes a bleaching agent, it can be included in an amount of between approximately 0.1% and approximately 60% by weight, between approximately 1% and approximately 20% by weight, between approximately 3% and approximately 8% by weight, and between approximately 3% and approximately 6% by weight.

### Fillers

The detergent composition can include an effective amount of detergent fillers which do not perform as a cleaning agent per se, but cooperates with the cleaning agent to enhance the overall cleaning capacity of the composition. Examples of detergent fillers suitable for use in the present compositions include, but are not limited to: sodium sulfate and sodium chloride. When the concentrate includes a detergent filler, it can be included in an amount up to approximately 50% by weight, between approximately 1% and approximately 30% by weight, or between approximately 1.5% and approximately 25% by weight.

### Defoaming Agents

A defoaming agent for reducing the stability of foam may also be included in the composition. Examples of defoaming agents include, but are not limited to: ethylene oxide/propylene block copolymers such as those available under the name Pluronic N-3; silicone compounds such as silica dispersed in polydimethylsiloxane, polydimethylsiloxane, and functionalized polydimethylsiloxane such as those available under the name Abil B9952; fatty amides, hydrocarbon waxes, fatty acids, fatty esters, fatty alcohols, fatty acid soaps, ethoxylates, mineral oils, polyethylene glycol esters, and alkyl phosphate esters such as monostearyl phosphate. A discussion of defoaming agents may be found, for example, in U.S. Pat. No. 3,048,548 to Martin et al., U.S. Pat. No. 3,334,147 to Brunelle et al., and U.S. Pat. No. 3,442,242 to Rue et al., the disclosures of which are incorporated herein by reference. When the concentrate includes a defoaming agent, the defoaming agent can be provided in an amount of between approximately 0.0001% and approximately 10% by weight, between approximately 0.001% and approximately 5% by weight, or between approximately 0.01% and approximately 1.0% by weight.

### Anti-Redeposition Agents

The detergent composition can include an anti-redeposition agent for facilitating sustained suspension of soils in a cleaning solution and preventing the removed soils from being redeposited onto the substrate being cleaned. Examples of suitable anti-redeposition agents include, but are not limited to: polyacrylates, styrene maleic anhydride copolymers, cellulosic derivatives such as hydroxyethyl cellulose, hydroxypropyl cellulose and carboxymethyl cellulose. When the concentrate includes an anti-redeposition agent, the anti-redeposition agent can be included in an amount of between approximately 0.5% and approximately 10% by weight, and between approximately 1% and approximately 5% by weight.

### Stabilizing Agents

The detergent composition may also include stabilizing agents. Examples of suitable stabilizing agents include, but are not limited to: borate, calcium/magnesium ions, propylene glycol, and mixtures thereof. The concentrate need not include a stabilizing agent, but when the concentrate includes a stabilizing agent, it can be included in an amount that provides the desired level of stability of the concentrate. Exemplary ranges of the stabilizing agent include up to approximately 20% by weight, between approximately 0.5% and approximately 15% by weight, and between approximately 2% and approximately 10% by weight.

### Dispersants

The detergent composition may also include dispersants. Examples of suitable dispersants that can be used in the detergent composition include, but are not limited to: maleic acid/olefin copolymers, polyacrylic acid, and mixtures thereof. The concentrate need not include a dispersant, but when a dispersant is included it can be included in an amount that provides the desired dispersant properties. Exemplary ranges of the dispersant in the concentrate can be up to approximately 20% by weight, between approximately 0.5% and approximately 15% by weight, and between approximately 2% and approximately 9% by weight.

### Enzymes

Enzymes that can be included in the detergent composition include those enzymes that aid in the removal of starch and/or protein stains. Exemplary types of enzymes include, but are not limited to: proteases, alpha-amylases, and mixtures thereof. Exemplary proteases that can be used include, but are not limited to: those derived from Bacillus licheniformix, Bacillus lenus, Bacillus alcalophilus, and Bacillus amyloliquefacins. Exemplary alpha-amylases include Bacillus subtilis, Bacillus amyloliquefaceins and Bacillus licheniformis. The concentrate need not include an enzyme, but when the concentrate includes an enzyme, it can be included in an amount that provides the desired enzymatic activity when the detergent composition is provided as a use composition. Exemplary ranges of the enzyme in the concentrate include up to approximately 15% by weight, between approximately 0.5% to approximately 10% by weight, and between approximately 1% to approximately 5% by weight.

### Glass and Metal Corrosion Inhibitors

The detergent composition can include a metal corrosion inhibitor in an amount up to approximately 50% by weight, between approximately 1% and approximately 40% by weight, or between approximately 3% and approximately 30% by weight. The corrosion inhibitor is included in the detergent composition in an amount sufficient to provide a use solution that exhibits a rate of corrosion and/or etching of glass that is less than the rate of corrosion and/or etching of glass for an otherwise identical use solution except for the absence of the corrosion inhibitor. It is expected that the use solution will include at least approximately 6 parts per million (ppm) of the corrosion inhibitor to provide desired corrosion inhibition properties. It is expected that larger amounts of corrosion inhibitor can be used in the use solution without deleterious effects. It is expected that at a certain point, the additive effect of increased corrosion and/or etching resistance with increasing corrosion inhibitor concentration will be lost, and additional corrosion inhibitor will simply increase the cost of using the detergent composition. The use solution can include between approximately 6 ppm and approximately 300 ppm of the corrosion inhibitor, and between approximately 20 ppm and approximately 200 ppm of the corrosion inhibitor. Examples of suitable corrosion inhibitors include, but are not limited to: a combination of a source of aluminum ion and a source of zinc ion, as well as an alkaline metal silicate or hydrate thereof.

The corrosion inhibitor can refer to the combination of a source of aluminum ion and a source of zinc ion. The source of aluminum ion and the source of zinc ion provide aluminum ion and zinc ion, respectively, when the detergent composition is provided in the form of a use solution. The amount of the corrosion inhibitor is calculated based upon the combined amount of the source of aluminum ion and the source of zinc ion. Anything that provides an aluminum ion in a use solution can be referred to as a source of aluminum ion, and anything that provides a zinc ion when provided in a use solution can be referred to as a source of zinc ion. It is not necessary for the source of aluminum ion and/or the source of zinc ion to react to form the aluminum ion and/or the zinc ion. Aluminum ions can be considered a source of aluminum ion, and zinc ions can be considered a source of zinc ion. The source of aluminum ion and the source of zinc ion can be provided as organic salts, inorganic salts, and mixtures thereof. Exemplary sources of aluminum ion include, but are not limited to: aluminum salts such as sodium aluminate, aluminum bromide, aluminum chlorate, aluminum chloride, aluminum iodide, aluminum nitrate, aluminum sulfate, aluminum acetate, aluminum formate, aluminum tartrate, aluminum lactate, aluminum oleate, aluminum bromate, aluminum borate, aluminum potassium sulfate, aluminum zinc sulfate, and aluminum phosphate. Exemplary sources of zinc ion include, but are not limited to: zinc salts such as zinc chloride, zinc sulfate, zinc nitrate, zinc iodide, zinc thiocyanate, zinc fluorosilicate, zinc dichromate, zinc chlorate, sodium zincate, zinc gluconate, zinc acetate, zinc benzoate, zinc citrate, zinc lactate, zinc formate, zinc bromate, zinc bromide, zinc fluoride, zinc fluorosilicate, and zinc salicylate.

The applicants discovered that by controlling the ratio of the aluminum ion to the zinc ion in the use solution, it is possible to provide reduced corrosion and/or etching of glassware and ceramics compared with the use of either component alone. That is, the combination of the aluminum ion and the zinc ion can provide a synergy in the reduction of corrosion and/or etching. The ratio of the source of aluminum ion to the source of zinc ion can be controlled to provide a synergistic effect. In general, the weight ratio of aluminum ion to zinc ion in the use solution can be between at least approximately 6:1, can be less than approximately 1:20, and can be between approximately 2:1 and approximately 1:15.

An effective amount of an alkaline metal silicate or hydrate thereof can be employed in the compositions and processes of the invention to form a stable detergent composition having metal protecting capacity. The silicates employed in the compositions of the invention are those that have conventionally been used in detergent formulations. For example, typical alkali metal silicates are those powdered, particulate or granular silicates which are either anhydrous or preferably which contain water of hydration (approximately 5% to approximately 25% by weight, particularly approximately 15% to approximately 20% by weight water of hydration). These silicates are preferably sodium silicates and have a Na2O:SiO2 ratio of approximately 1:1 to approximately 1:5, respectively, and typically contain available water in the amount of from approximately 5% to approximately 25% by weight. In general, the silicates have a Na2O:SiO2 ratio of approximately 1:1 to approximately 1:3.75, particularly approximately 1:1.5 to approximately 1:3.75 and most particularly approximately 1:1.5 to approximately 1:2.5. A silicate with a Na2O:SiO2 ratio of approximately 1:2 and approximately 16% to approximately 22% by weight water of hydration, is most preferred. For example, such silicates are available in powder form as GD Silicate and in granular form as Britesil H-20, available from PQ Corporation, Valley Forge, Pa. These ratios may be obtained with single silicate compositions or combinations of silicates which upon combination result in the preferred ratio. The hydrated silicates at preferred ratios, a Na2O:SiO2 ratio of approximately 1:1.5 to approximately 1:2.5, have been found to provide the optimum metal protection. Hydrated silicates are preferred.

Silicates can be included in the detergent composition to provide for metal protection but are additionally known to provide alkalinity and additionally function as anti-redeposition agents. Exemplary silicates include, but are not limited to: sodium silicate and potassium silicate. The detergent composition can be provided without silicates, but when silicates are included, they can be included in amounts that provide for desired metal protection. The concentrate can include silicates in amounts of at least approximately 1% by weight, at least approximately 5% by weight, at least approximately 10% by weight, and at least approximately 15% by weight. In addition, in order to provide sufficient room for other components in the concentrate, the silicate component can be provided at a level of less than approximately 35% by weight, less than approximately 25% by weight, less than approximately 20% by weight, and less than approximately 15% by weight.

### Fragrances and Dyes

Various dyes, odorants including perfumes, and other aesthetic enhancing agents can also be included in the composition. Suitable dyes that may be included to alter the appearance of the composition, include, but are not limited to: Direct Blue 86, available from Mac Dye-Chem Industries, Ahmedabad, India; Fastusol Blue, available from Mobay Chemical Corporation, Pittsburgh, Pa.; Acid Orange 7, available from American Cyanamid Company, Wayne, N.J.; Basic Violet 10 and Sandolan Blue/Acid Blue 182, available from Sandoz, Princeton, N.J.; Acid Yellow 23, available from Chemos GmbH, Regenstauf, Germany; Acid Yellow 17, available from Sigma Chemical, St. Louis, Mo.; Sap Green and Metanil Yellow, available from Keyston Analine and Chemical, Chicago, Ill.; Acid Blue 9, available from Emerald Hilton Davis, LLC, Cincinnati, Ohio; Hisol Fast Red and Fluorescein, available from Capitol Color and Chemical Company, Newark, N.J.; and Acid Green 25, Ciba Specialty Chemicals Corporation, Greenboro, N.C.

Fragrances or perfumes that may be included in the compositions include, but are not limited to: terpenoids such as citronellol, aldehydes such as amyl cinnamaldehyde, a jasmine such as C1S-jasmine or jasmal, and vanillin.

### Thickeners

The detergent compositions can include a rheology modifier or a thickener. The rheology modifier may provide the following functions: increasing the viscosity of the compositions; increasing the particle size of liquid use solutions when dispensed through a spray nozzle; providing the use solutions with vertical cling to surfaces; providing particle suspension within the use solutions; or reducing the evaporation rate of the use solutions.

The rheology modifier may provide a use composition that is pseudo plastic, in other words the use composition or material when left undisturbed (in a shear mode), retains a high viscosity. However, when sheared, the viscosity of the material is substantially but reversibly reduced. After the shear action is removed, the viscosity returns. These properties permit the application of the material through a spray head. When sprayed through a nozzle, the material undergoes shear as it is drawn up a feed tube into a spray head under the influence of pressure and is sheared by the action of a pump in a pump action sprayer. In either case, the viscosity can drop to a point such that substantial quantities of the material can be applied using the spray devices used to apply the material to a soiled surface. However, once the material comes to rest on a soiled surface, the materials can regain high viscosity to ensure that the material remains in place on the soil. Preferably, the material can be applied to a surface resulting in a substantial coating of the material that provides the cleaning components in sufficient concentration to result in lifting and removal of the hardened or baked-on soil. While in contact with the soil on vertical or inclined surfaces, the thickeners in conjunction with the other components of the cleaner minimize dripping, sagging, slumping or other movement of the material under the effects of gravity. The material should be formulated such that the viscosity of the material is adequate to maintain contact between substantial quantities of the film of the material with the soil for at least a minute, particularly five minutes or more.

Examples of suitable thickeners or rheology modifiers are polymeric thickeners including, but not limited to: polymers or natural polymers or gums derived from plant or animal sources. Such materials may be polysaccharides such as large polysaccharide molecules having substantial thickening capacity. Thickeners or rheology modifiers also include clays.

A substantially soluble polymeric thickener can be used to provide increased viscosity or increased conductivity to the use compositions. Examples of polymeric thickeners for the aqueous compositions of the invention include, but are not limited to: carboxylated vinyl polymers such as polyacrylic acids and sodium salts thereof, ethoxylated cellulose, polyacrylamide thickeners, cross-linked, xanthan compositions, sodium alginate and algin products, hydroxypropyl cellulose, hydroxyethyl cellulose, and other similar aqueous thickeners that have some substantial proportion of water solubility. Examples of suitable commercially available thickeners include, but are not limited to: Acusol, available from Rohm & Haas Company, Philadelphia, Pa.; and Carbopol, available from B.F. Goodrich, Charlotte, N.C.

Examples of suitable polymeric thickeners include, but not limited to: polysaccharides. An example of a suitable commercially available polysaccharide includes, but is not limited to, Diutan, available from Kelco Division of Merck, San Diego, Calif. Thickeners for use in the detergent compositions further include polyvinyl alcohol thickeners, such as, fully hydrolyzed (greater than 98.5 mol acetate replaced with the —OH function).

An example of a particularly suitable polysaccharide includes, but is not limited to, xanthans. Such xanthan polymers are preferred due to their high water solubility, and great thickening power. Xanthan is an extracellular polysaccharide of xanthomonas campestras. Xanthan may be made by fermentation based on corn sugar or other corn sweetener by-products. Xanthan comprises a poly beta-(1-4)-D-Glucopyranosyl backbone chain, similar to that found in cellulose. Aqueous dispersions of xanthan gum and its derivatives exhibit novel and remarkable rheological properties. Low concentrations of the gum have relatively high viscosities which permit it to be used economically. Xanthan gum solutions exhibit high pseudo plasticity, i.e. over a wide range of concentrations, rapid shear thinning occurs that is generally understood to be instantaneously reversible. Non-sheared materials have viscosities that appear to be independent of the pH and independent of temperature over wide ranges. Preferred xanthan materials include crosslinked xanthan materials. Xanthan polymers can be crosslinked with a variety of known covalent reacting crosslinking agents reactive with the hydroxyl functionality of large polysaccharide molecules and can also be crosslinked using divalent, trivalent or polyvalent metal ions. Such crosslinked xanthan gels are disclosed in U.S. Pat. No. 4,782,901, which is herein incorporated by reference. Suitable crosslinking agents for xanthan materials include, but are not limited to: metal cations such as Al+3, Fe+3, Sb+3, Zr+4 and other transition metals. Examples of suitable commercially available xanthans include, but are not limited to: KELTROL®, KELZAN® AR, KELZAN® D35, KELZAN® S, KELZAN® XZ, available from Kelco Division of Merck, San Diego, Calif. Known organic crosslinking agents can also be used. A preferred crosslinked xanthan is KELZAN® AR, which provides a pseudo plastic use solution that can produce large particle size mist or aerosol when sprayed.

### Disintegrants

Solid detergent compositions of the present invention may be free of or may be substantially free of disintegrants. The term, “disintegrant,” as used herein include those chemicals that when added to a solid composition enhance disintegration. In other words, a “disintegrant” allows a solid composition to more rapidly disperse and/or dissolve in water. The present invention provides solid compositions that may be free of such disintegrants. Examples of disintegrants include starches that swell upon exposure to water, cellulose and its derivatives, alginates, and a couple of miscellaneous chemicals discussed below.

Starches (amylum) may be avoided in solid compositions of the invention. Starches work to disintegrate solid compositions by a mechanical action. Upon contact with aqueous fluids, starches swell thereby placing stress upon the solid composition in which they reside. Such stress is responsible for disruption of hydrogen bonding formed during compression of a solid detergent. Since starches are useful in assisting in rapid tablet disintegration, they may be avoided in solid compositions of the invention. Such starches that may be avoided in solid compositions of the present invention may include pregelatinized starch and modified starch such as sodium starch glycolate (available commercially as Primogel™ or Explotab™). Modified starches that have high swelling properties and therefore allow for faster disintegration include those modified by carboxy methylation followed by cross linking. Such starches exhibit rapid and extensive swelling with minimum gelling.

Cellulose and its derivatives such as sodium carboxy methylcellulose have highly hydrophilic structures and are very soluble in water. However, when cellulose is modified by internal crosslinking crosscarmellose sodium results which is nearly water insoluble and rapidly swells to 4-8 times its original volume contacting water. Microcrystalline cellulose is another insoluble cellulose that causes disintegration of a solid composition by wicking action. The wicked moisture works to break hydrogen bonding between adjacent bundles of microcrystalline cellulose. As such, these celluloses and its derivatives may be avoided in solid compositions of the present invention.

Alginates such as alginic acid and sodium alginate are further examples of disintegrants one may avoid in solid compositions of the present invention. Alginates are hydrophilic colloidal substances which have high sorption capacity which, upon exposure to water, work to mechanically degrade a solid composition.

Miscellaneous disintegrants including gas-producing disintegrants and hydrous aluminum silicate may also be excluded from compositions of the present invention. Gas producing disintegrating agents include commercially available Polyplasdone XL and Polyplasdone XL10 that act by wicking and swelling. Such miscellaneous disintegrants do not affect product hardness but provide rapid disintegration and improved dissolution. As such, solid compositions of the invention are desirably free of such miscellaneous disintegrants.

### Methods of Manufacture and Use

The detergent composition of the present invention can be formed by combining the AMPS polymer, maleic acid polymer, optional weak complexing agent, alkaline source and other desired components in the weight percentages and ratios disclosed herein. The detergent may be provided as a solid, as a liquid concentrate, and/or as a use solution constituting an aqueous solution or dispersion of the concentrate. Such use solutions may be formed during the washing process such as during machine textile or warewashing processes.

Solid detergent compositions formed using the solidification matrix are produced using a batch or continuous mixing system. In an exemplary embodiment, a single- or twin-screw extruder is used to combine and mix one or more cleaning agents at high shear to form a homogeneous mixture. In some embodiments, the processing temperature is at or below the melting temperature of the components. The processed mixture may be dispensed from the mixer by forming, casting or other suitable means, whereupon the detergent composition hardens to a solid form. The structure of the matrix may be characterized according to its hardness, melting point, material distribution, crystal structure, and other like properties according to known methods in the art. Generally, a solid detergent composition processed according to the method of the invention is substantially homogeneous with regard to the distribution of ingredients throughout its mass and is dimensionally stable.

Specifically, in a forming process, the liquid and solid components are introduced into the final mixing system and are continuously mixed until the components form a substantially homogeneous semi-solid mixture in which the components are distributed throughout its mass. In an exemplary embodiment, the components are mixed in the mixing system for at least approximately 5 seconds. The mixture is then discharged from the mixing system into, or through, a die or other shaping means. The product is then packaged. In an exemplary embodiment, the formed composition begins to harden to a solid form in between approximately 1 minute and approximately 3 hours. Particularly, the formed composition begins to harden to a solid form in between approximately 1 minute and approximately 2 hours. More particularly, the formed composition begins to harden to a solid form in between approximately 1 minute and approximately 20 minutes.

Specifically, in a casting process, the liquid and solid components are introduced into the final mixing system and are continuously mixed until the components form a substantially homogeneous liquid mixture in which the components are distributed throughout its mass. In an exemplary embodiment, the components are mixed in the mixing system for at least approximately 60 seconds. Once the mixing is complete, the product is transferred to a packaging container where solidification takes place. In an exemplary embodiment, the cast composition begins to harden to a solid form in between approximately 1 minute and approximately 3 hours. Particularly, the cast composition begins to harden to a solid form in between approximately 1 minute and approximately 2 hours. More particularly, the cast composition begins to harden to a solid form in between approximately 1 minute and approximately 20 minutes.

By the term “solid form”, it is meant that the hardened composition will not flow and will substantially retain its shape under moderate stress or pressure or mere gravity. The degree of hardness of the solid cast composition may range from that of a fused solid product which is relatively dense and hard, for example, like concrete, to a consistency characterized as being a hardened paste. In addition, the term “solid” refers to the state of the detergent composition under the expected conditions of storage and use of the solid detergent composition. In general, it is expected that the detergent composition will remain in solid form when exposed to temperatures of up to approximately 100 oF and particularly greater than approximately 120 oF.

The resulting solid detergent composition may take forms including, but not limited to: a cast solid product; an extruded, molded or formed solid pellet, block, tablet, powder, granule, flake; or the formed solid can thereafter be ground or formed into a powder, granule, or flake. In an exemplary embodiment, extruded pellet materials formed by the solidification matrix have a weight of between approximately 50 grams and approximately 250 grams, extruded solids formed by the solidification matrix have a weight of approximately 100 grams or greater, and solid block detergents formed by the solidification matrix have a mass of between approximately 1 and approximately 10 kilograms. The solid compositions provide for a stabilized source of functional materials. In some embodiments, the solid composition may be dissolved, for example, in an aqueous or other medium, to create a concentrated and/or use solution. The solution may be directed to a storage reservoir for later use and/or dilution, or may be applied directly to a point of use.

In certain embodiments, the solid detergent composition is provided in the form of a unit dose. A unit dose refers to a solid detergent composition unit sized so that the entire unit is used during a single washing cycle. When the solid detergent composition is provided as a unit dose, it is typically provided as a cast solid, an extruded pellet, or a tablet having a size of between approximately 1 gram and approximately 50 grams.

In other embodiments, the solid detergent composition is provided in the form of a multiple-use solid, such as a block or a plurality of pellets, and can be repeatedly used to generate aqueous detergent compositions for multiple washing cycles. In certain embodiments, the solid detergent composition is provided as a cast solid, an extruded block, or a tablet having a mass of between approximately 5 grams and approximately 10 kilograms. In certain embodiments, a multiple-use form of the solid detergent composition has a mass between approximately 1 kilogram and approximately 10 kilograms. In further embodiments, a multiple-use form of the solid detergent composition has a mass of between approximately 5 kilograms and about approximately 8 kilograms. In other embodiments, a multiple-use form of the solid detergent composition has a mass of between about approximately 5 grams and approximately 1 kilogram, or between approximately 5 grams and approximately 500 grams. Although the detergent composition is discussed as being formed into a solid product, the detergent composition may also be provided in the form of a paste or liquid by adding sufficient water or solvent to the composition.

In use, the detergent composition may be diluted with water to form use compositions or solutions. The typical dilution factor is between approximately 1 and approximately 10,000 but will depend on factors including water hardness, the amount of soil to be removed and the like. In an embodiment, the concentrate is diluted at a ratio of between about 1:10 and about 1:10000 concentrate to water. Particularly, the concentrate is diluted at a ratio of between about 1:100 and about 1:5000 concentrate to water. More particularly, the concentrate is diluted at a ratio of between about 1:250 and about 1:2000 concentrate to water. Accordingly, the concentration of the individual components in the use solution will be significantly lower than for the concentrated form of the detergent composition.

For example, the use solution may have an active component concentration of between about 40 and about 8,000 parts per million (ppm), more particularly, between approximately 200 and approximately 3,000 ppm, even more particularly, from about 400 to about 2000 ppm. Ranges for the component concentrations are provided in Table 2 below:

TABLE 2

| | Embodiment | Embodiment | Embodiment |
|---|---|---|---|
| Material | #1 | #2 | #3 |
| AMPS copolymer | 10-1000 ppm | 10-250 ppm | 25-250 ppm |
| Maleic acid polymer | 10-1000 ppm | 10-250 ppm | 25-250 ppm |
| Sodium Hydroxide | 10-5000 ppm | 100-2000 ppm | 200-1000 ppm |
| Weak Complexing | 10-1000 ppm | 10-250 ppm | 25-250 ppm |
| Agent | | | |

### EXAMPLES

The present invention is more particularly described in the following examples that are intended as illustrations only, since numerous modifications and variations within the scope of the present invention will be apparent to those skilled in the art. Unless otherwise noted, all parts, percentages, and ratios reported in the following examples are on a weight basis, and all reagents used in the examples were obtained, or are available, from the chemical suppliers described below, or may be synthesized by conventional techniques.

### Materials Used

TABLE 3

| Abbreviation | Material | Commercial Name | Source |
|---|---|---|---|
| AR 545 | Acrylic acid/AMPS | Aquatreat AR 545 | Akzo Nobel |
| | copolymer | | |
| AR 801 | Maleic acid homopolymer | Aquatreat AR 801 | Akzo Nobel |
| Tiron | 4,5dihydroxy-m- | Tiron | Multiple |
| | benzenedisulfonic acid | | |
| | disodium salt | | |
| Gantrez | Poly(methylvinylether/maleic | Gantrez S95 | ISP |
| | acid) copolymer | | |
| Pluronic | Ethylene oxide/propylene | Pluronic N3 | BASF |
| | oxide copolymer | | |
| Saccharate | Monopotassium Saccharate | N/A | Multiple |
| Catechol | Benzene-1,2-diol | N/A | Multiple |
| EDTA | Ethylenediamine tetraacetic | N/A | Multiple |
| | acid | | |
| Trilon M | Trisodium salt of | Trilon M | BASF |
| | methylglycinediacetic acid | | |
| GLDA | 1-glutamicacid, N,N-di | N/A | Multiple |
| | (acetic acid), tetrasodium salt | | |
| SC50 | Acrylic acid/AMPS | Sokalan CP50 | BASF |
| | copolymer | | |
| AC2000 | Acrylic acid/AMPS | Acumer 2000 | Dow |
| | copolymer | | |
| Opti 4210 | Maleic acid polymer | Optidose 4210 | Dow |
| CO3 | Sodium Carbonate | N/A | Multiple |
| NaOH, 50% | 50 wt % aqueous solution of | N/A | Multiple |
| | Sodium hydroxide | | |
| NaOH Beads | Solid beads of sodium | N/A | Multiple |
| | hydroxide | | |
| Glucose | (2R,3S,4R,5R)-2,3,5,4,6- | N/A | Multiple |
| | Pentahydroxyhexanal | | |
| STPP | Sodium triphosphate | N/A | Multiple |
| Lactic Acid | 88% lactic Acid | N/A | Multiple |
| Sodium Citrate | Sodium Citrate dihydrate | N/A | Multiple |
| Tartaric Acid | 99 wt % tartaric acid | N/A | Multiple |
| Sodium Tartrate | Sodium Tartrate dihydrate | N/A | Multiple |

### Beaker Test

A hardness solution was prepared by dissolving 33.45 g of CaCl₂.2H₂O and 23.24 g of MGCl₂.6H₂O in DI water in a 1 L volumetric flask filled to volume. A sodium bicarbonate solution was prepared by dissolving NaHCO₃.2H₂O in DI water in a 1 L volumetric flask filled to volume.

A beaker was placed on a heat plate/stirrer. To the beaker, 1000 ml DI water and 5.00 m of the sodium bicarbonate solution were added. The contents of the beaker were heated to 85° F. and then the hardness solution was added to provide a water harness of 17 grains. Then each component of the Sample provided in the tables below were added to the contents of the beaker in the identified concentrations.

After the Sample was completely mixed into the beaker, an initial transmittance measurement at 560 nm was taken at 85° F., 140° F., and 160° F. The Sample was then allowed to cool to room temperature before a final measurement was taken.

A “Clear” Sample as set forth in the tables below indicates that the beaker contents had a light transmission of at least about 95% when tested at 85° F., 140° F., 160° F. and room temperature, and was visibly clear without noticeable haziness, discoloration or precipitant formation. The fact that a particular Sample was not indicated as being clear does not necessarily mean that the Sample did not prevent scale. Rather, those Samples that are indicated as being clear provide optimum scale protection under the conditions created in the experiment.

### 100-Cycle Machine Test

Six Libbey heat resistant glass tumblers and one Cambro Newport plastic tumbler were placed on a Raburn glass rack, which was placed in a Hobart AM-15 institutional dishwasher machine. The machine was then filled with water, which was tested for water hardness. The tank heaters were then turned on and wash/rinse cycles were run at 150-160° F. and 175-190° F., respectively. During the wash cycle, the machine controller was set to dispense the Sample components in the appropriate amount to achieve the concentrations indicated in the Tables below. Titrations were run to confirm that concentrations were correct. The foregoing cycle was run 100 times for each Sample.

### Light Box Test

The light box test used a digital camera, a light box, a light source, a light meter and a control computer employing “Spot Advance” and “Image Pro Plus” commercial software. A glass to be evaluated was placed on its side on the light box, and the intensity of the light source was adjusted to a predetermined value using the light meter. A photographic image of the glass was taken and saved to the computer. The software was then used to analyze the upper half of the glass, and the computer then displayed a histogram graph with the area under the graph being proportional to the thickness of the film. A new glass tumbler run has a benchmark light score of 12,000. A light box score of less than 35,000 after the 100 cycle test is generally considered to be exemplary. The scores provided in the Tables below were an average of the six glasses run through the 100 cycle test.

### Example 1

Beaker tests were run for Samples 1-14, which included an alkaline component, an AMPS copolymer and a maleic polymer. Samples 1 and 10 also included Bayhibit AM, a phosphonate. The component concentrations provided in Table 4 below indicate the active amount of the components in the beaker. A complexing agent was not used in these Samples.

TABLE 4

| Samp. | Alkaline | PPM | AMPS | PPM | PBTC | PPM | Polymer | PPM | Clear |
|---|---|---|---|---|---|---|---|---|---|
| 1 | NaOH | 350 | AR 545 | 40 | AM | 8 | Gantrez | 5 | No |
| 2 | NaOH | 350 | AR 545 | 40 | No | 0 | AR 801 | 40 | Yes |
| 3 | CO3 | 910 | AR 545 | 40 | No | 0 | AR 801 | 40 | No |
| 4 | NaOH | 350 | AR 545 | 50 | No | 0 | AR 801 | 40 | No |
| 5 | NaOH | 350 | AC2000 | 40 | No | 0 | AR 801 | 40 | No |
| 6 | NaOH | 350 | SC50 | 40 | No | 0 | AR 801 | 40 | No |
| 7 | NaOH | 350 | SC50 | 40 | No | 0 | Opti 4210 | 40 | No |
| 8 | NaOH | 350 | AR 545 | 40 | No | 0 | Opti 4210 | 40 | Yes |
| 9 | NaOH | 350 | AC2000 | 40 | No | 0 | Opti 4210 | 40 | Yes |
| 10 | CO3 | 910 | SC50 | 40 | AM | 8 | AR 801 | 40 | Yes |
| 11 | CO3 | 910 | AC2000 | 40 | No | 0 | AR 801 | 40 | Yes |
| 12 | NaOH/ | 350 | AC2000 | 40 | No | 0 | AR 801 | 40 | No |
| | CO3 | 300 | | | | | | | |
| 13 | NaOH/ | 350 | SC50 | 40 | No | 0 | AR 801 | 40 | No |
| | CO3 | 300 | | | | | | | |
| 14 | NaOH/ | 330 | SC50 | 40 | No | 0 | AR 801 | 40 | No |
| | CO3 | 300 | | | | | | | |

The test results indicate that Samples 2 and 8-11 were “clear,” meaning that the beaker contents had a light transmission of at least 95% when tested at 85° F., 140° F., 160° F. and room temperature, and was visibly clear without noticeable haziness, discoloration or precipitant formation.

### Example 2

Beaker tests were run for Samples 15-20, which included an alkaline component, an AMPS copolymer, a maleic polymer and sodium citrate dihydrate. The component concentrations provided in Table 5 below indicate the active amount of the components in the beaker.

TABLE 5

| | | | | | | | | | Sodium | |
|---|---|---|---|---|---|---|---|---|---|---|
| | | | | | | | | | Citrate | |
| Samp. | Alkaline | PPM | AMPS | PPM | PBTC | PPM | Polymer | PPM | (PPM) | Clear |
| 15 | NaOH | 350 | AR 545 | 80 | No | 0 | AR 801 | 40 | 300 | Yes |
| 16 | NaOH | 350 | AR 545 | 40 | No | 0 | AR 801 | 40 | 300 | Yes |
| 17 | NaOH | 350 | AR 545 | 40 | No | 0 | AR 801 | 40 | 150 | Yes |
| 18 | NaOH | 350 | AR 545 | 40 | No | 0 | AR 801 | 20 | 300 | Yes |
| 19 | CO3 | 910 | AR 545 | 40 | No | 0 | AR 801 | 20 | 150 | Yes |
| 20 | NaOH | 350 | AC2000 | 40 | No | 0 | AR 801 | 40 | 150 | Yes |

The test results indicate that each of Samples 15-20 was “clear,” meaning that the beaker contents had a light transmission of at least 95% when tested at 85° F., 140° F., 160° F. and room temperature, and was visibly clear without noticeable haziness, discoloration or precipitant formation.

### Example 3

Beaker tests were run for Samples 21-37, which included an alkaline component, an AMPS copolymer, a maleic polymer and sodium tartrate dihydrate. The component concentrations provided in Table 6 below indicate the active amount of the components in the beaker.

TABLE 6

| | | | | | | | | | Tart. acid | |
|---|---|---|---|---|---|---|---|---|---|---|
| Samp. | Alkaline | PPM | AMPS | PPM | PBTC | PPM | Polymer | PPM | (PPM) | Clear |
| 21 | NaOH | 350 | AR 545 | 40 | No | 0 | AR 801 | 40 | 50 | No |
| 22 | NaOH | 350 | AR 545 | 40 | No | 0 | AR 801 | 40 | 100 | Yes |
| 23 | CO3 | 910 | AR 545 | 40 | No | 0 | AR 801 | 40 | 100 | Yes |
| 24 | CO3 | 910 | AR 545 | 40 | No | 0 | AR 801 | 40 | 50 | Yes |
| 25 | NaOH | 330 | AR 545 | 40 | No | 0 | AR 801 | 40 | 100 | Yes |
| | CO3 | 300 | | | | | | | | |
| 26 | NaOH | 330 | AR 545 | 40 | No | 0 | AR 801 | 40 | 50 | Yes |
| | CO3 | 300 | | | | | | | | |
| 27 | NaOH | 350 | AC2000 | 40 | No | 0 | AR 801 | 40 | 150 | Yes |
| 28 | NaOH | 350 | SC50 | 40 | No | 0 | AR 801 | 40 | 200 | Yes |
| 29 | NaOH | 350 | SC50 | 40 | No | 0 | Opti 4210 | 40 | 200 | No |
| 30 | NaOH | 350 | AC2000 | 40 | No | 0 | Opti 4210 | 40 | 100 | Yes |
| 31 | NaOH | 450 | SC50 | 40 | No | 0 | AR 801 | 40 | 100 | Yes |
| 32 | CO3 | 910 | AC2000 | 40 | No | 0 | AR 801 | 40 | 100 | Yes |
| 33 | NaOH/ | 330 | SC50 | 40 | No | 0 | AR 801 | 40 | 100 | Yes |
| | CO3 | 300 | | | | | | | | |
| 34 | NaOH/ | 330 | SC50 | 40 | No | 0 | AR 801 | 40 | 150 | Yes |
| | CO3 | 300 | | | | | | | | |
| 35 | NaOH/ | 330 | AC2000 | 40 | No | 0 | AR 801 | 40 | 100 | No |
| | CO3 | 300 | | | | | | | | |
| 36 | NaOH/ | 330 | AC2000 | 40 | No | 0 | AR 801 | 40 | 150 | Yes |
| | CO3 | 300 | | | | | | | | |

The test results indicate that Samples 22-28, 30-34 and 36 were “clear,” meaning that the beaker contents had a light transmission of at least 95% when tested at 85° F., 140° F., 160° F. and room temperature, and was visibly clear without noticeable haziness, discoloration or precipitant formation.

### Example 4

Beaker tests were run for Samples 37-59, which included an alkaline component, an AMPS copolymer, a maleic polymer and the identified complexing agent. The component concentrations provided in Table 7 below indicate the active amount of the components in the beaker.

TABLE 7

| | | | AR545 | | | | | Complex. | | |
|---|---|---|---|---|---|---|---|---|---|---|
| Samp. | Alkaline | PPM | (PPM) | PBTC | PPM | Polymer | PPM | Agent | PPM | Clear |
| 37 | NaOH | 350 | 40 | No | 0 | AR 801 | 40 | Tiron | 100 | Yes |
| 38 | NaOH | 350 | 40 | No | 0 | AR 801 | 40 | Maleic | 100 | No |
| | | | | | | | | acid | | |
| 39 | NaOH | 350 | 40 | No | 0 | AR 801 | 40 | Tiron | 50 | Yes |
| 40 | NaOH | 350 | 40 | No | 0 | AR 801 | 40 | Tiron | 20 | No |
| 41 | NaOH | 350 | 40 | No | 0 | AR 801 | 40 | Tiron | 30 | No |
| 42 | NaOH | 350 | 40 | No | 0 | AR 801 | 40 | Catechol | 50 | Yes |
| 43 | NaOH | 350 | 40 | No | 0 | AR 801 | 40 | Catechol | 20 | Yes |
| 44 | NaOH | 350 | 40 | No | 0 | AR 801 | 40 | Glucose | 100 | No |
| 45 | NaOH | 350 | 40 | No | 0 | AR 801 | 40 | Glucose | 200 | No |
| 46 | CO3 | 910 | 40 | No | 0 | AR 801 | 40 | Glucose | 50 | Yes |
| 47 | CO3 | 910 | 40 | No | 0 | AR 801 | 40 | Glucose | 100 | Yes |
| 48 | NaOH | 350 | 40 | No | 0 | AR 801 | 40 | EDTA | 50 | No |
| 49 | NaOH | 350 | 40 | No | 0 | AR 801 | 40 | EDTA | 100 | Yes |
| 50 | NaOH | 350 | 40 | No | 0 | AR 801 | 40 | EDTA | 150 | Yes |
| 51 | NaOH | 350 | 40 | No | 0 | AR 801 | 40 | EDTA | 200 | Yes |
| 52 | NaOH | 330 | 40 | No | 0 | AR 801 | 40 | EDTA | 150 | Yes |
| | CO3 | 300 | | | | | | | | |
| 53 | NaOH | 350 | 40 | No | 0 | AR 801 | 40 | STPP | 50 | No |
| 54 | NaOH | 350 | 40 | No | 0 | AR 801 | 40 | STPP | 100 | No |
| 55 | NaOH | 350 | 40 | No | 0 | AR 801 | 40 | Trilon M | 100 | Yes |
| 56 | NaOH | 350 | 40 | No | 0 | AR 801 | 40 | GLDA | 100 | No |
| 57 | NaOH | 350 | 40 | No | 0 | AR 801 | 40 | GLDA | 150 | Yes |
| 58 | NaOH | 450 | 40 | NO | 0 | AR 801 | 40 | Lactic | 150 | Yes |
| | | | (SC50) | | | | | Acid | | |
| 59 | NaOH | 350 | 40 | No | 0 | AR 801 | 40 | Saccharate | 200 | Yes |

The test results indicate that Samples 37, 39, 42-43, 46-47, 49-52, 55 and 57-59 were “clear,” meaning that the beaker contents had a light transmission of at least 95% when tested at 85° F., 140° F., 160° F. and room temperature, and was visibly clear without noticeable haziness, discoloration or precipitant formation.

### Example 5

Machine tests for Samples 60-65 were run as set forth above using 10 grain water. The component and total detergent concentrations used during the wash cycle are provided in Table 8. It will be noted that the concentrations provided below are based on total component concentrations, which are not necessarily equal to the active component concentrations. Active component concentrations can be determined using the information in the tables and materials summary.

TABLE 8

| | Samp. | Samp. | Samp. | Samp. | Samp. | Samp. |
|---|---|---|---|---|---|---|
| Material | 60 | 61 | 62 | 63 | 64 | 65 |
| NaOH Beads | 400.08 | 387.52 | 387.52 | 423.79 | 379.44 | 310.46 |
| NaOH 50% | 6.44 | | | 20.40 | | |
| AR 545 | 88.90 | | | | 78.43 | |
| AR 801 | 100.00 | 136.11 | 136.11 | 100.00 | 88.24 | 88.24 |
| AC2000 | | | | | | 82.08 |
| SC50 | | 59.18 | 59.18 | 43.48 | | |
| Sodium | | | 132.95 | | | 88.24 |
| Citrate | | | | | | |
| Dihydrate | | | | | | |
| Sodium | 100.00 | 178.85 | | | 135.26 | |
| Tartrate | | | | | | |
| Dihydrate | | | | | | |
| Lactic Acid | | | | 170.45 | | |
| Pluronic | 6.00 | 4.67 | 4.67 | 6.00 | 3.53 | |
| Total PPM | 701.42 | 766.33 | 720.43 | 764.12 | 684.89 | 569.01 |

TABLE 9

| | Light Box Mean Glass | Above/Below Water | |
|---|---|---|---|
| Sample | Score | Level | Heating Coil |
| 60 | 12193.94 | Clean/Clean | Clean |
| 61 | 20131.63 | Clean/Clean | Scaled |
| 62 | 19514.92 | Clean/Clean | Clean |
| 63 | 17107.46 | Clean/Clean | Clean |
| 64 | 21377.02 | Clean/Clean | Scaled |
| 65 | 26173.08 | Clean/Clean | Clean |

The results provided in Table 9 indicate that Samples 61-65 had average light scores of between about 12,000 and a little over 26,000. A visual inspection of the dishwashing machine after the tests showed that the machine was clean from scale above and below the water line and generally clean on the heating coil, with the exception of some scaling for samples 61 and 64.

### Example 6

Machine tests for Samples 66-71, each including sodium citrate dihydrate, were run as set forth above using 17 grain water. The component and total detergent concentrations used during the wash cycle are provided in Table 10. It will be noted that the concentrations provided below are based on total component concentrations, which are not necessarily equal to the active component concentrations. Active component concentrations can be determined using the information in the tables and materials summary.

TABLE 10

| | Samp. | Samp. | Samp. | Samp. | Samp. | Samp. |
|---|---|---|---|---|---|---|
| Material | 66 | 67 | 68 | 69 | 70 | 71 |
| NaOH Beads | 401.15 | 498.24 | 401.00 | 527.79 | 334.82 | 387.36 |
| NaOH 50% | | | | | 85.53 | |
| AR 545 | 88.89 | | 89.00 | | | 88.89 |
| AR 801 | 100.00 | 175.00 | 100.00 | 150.00 | 100.00 | 100.00 |
| AC2000 | | | | 139.53 | | |
| SC50 | | 76.09 | | | 43.48 | |
| Sodium | 170.00 | 170.94 | 170.00 | 150.00 | 170.93 | 170.00 |
| Citrate | | | | | | |
| Dihydrate | | | | | | |
| Gluconate | | | 100.00 | | | |
| Pluronic | 6.00 | 6.00 | 6.00 | 6.00 | 6.00 | 6.00 |
| Total PPM | 766.04 | 926.27 | 866.00 | 967.32 | 569.83 | 752.25 |

TABLE 11

| | Light Box Mean Glass | Above/Below Water | |
|---|---|---|---|
| Sample | Score | Level | Heating Coil |
| 66 | 28245.94 | Scale/Clean | Scale |
| 67 | 18804.16 | Clean/Clean | Scale |
| 68 | 34813.97 | Scale/Scale | Scale |
| 69 | 40431.14 | Clean/Clean | Scale |
| 70 | 29683.68 | Clean/Clean | Scale |
| 71 | 26105.99 | Clean/Scale | Clean |

The results provided in Table 11 indicate that Samples 66-69 and 71 had average light scores of less than 35,000. A visual inspection of the dishwashing machine after the test showed that the machine was generally clean from scale above and below the water line for the Samples with scaling on the heating coil.

### Example 7

Machine tests for Samples 72-77, each including tartaric acid or sodium tartrate dihydrate, and Sample 82, using lactic acid, were run as set forth above using 17 grain water. The component and total detergent concentrations used during the wash cycle are provided in Table 12. It will be noted that the concentrations provided below are based on total component concentrations, which are not necessarily equal to the active component concentrations. Active component concentrations can be determined using the information in the tables and materials summary.

TABLE 12

| | Samp. | Samp. | Samp. | Samp. | Samp. | Samp. |
|---|---|---|---|---|---|---|
| Material | 72 | 73 | 74 | 75 | 76 | 77 |
| NaOH Beads | 680.14 | 440.09 | 645.04 | 401.15 | 498.24 | 434.00 |
| NaOH 50% | 10.95 | 7.08 | | | | |
| AR 545 | 151.13 | 97.79 | 133.33 | 88.89 | | |
| AR 801 | 170.00 | 110.00 | 150.00 | 100.00 | 175.00 | 100.00 |
| SC50 | | | | | 76.09 | 43.48 |
| Tartaric | 170.00 | 110.00 | | | | |
| Acid | | | | | | |
| Sodium | | | 229.95 | 153.33 | 229.95 | |
| Tartrate | | | | | | |
| Dihydrate | | | | | | |
| Lactic Acid | | | | | | 170.00 |
| Pluronic N3 | 10.20 | 6.60 | 6.00 | 6.00 | 6.00 | 6.00 |
| Total PPM | 1192.41 | 771.56 | 1164.32 | 749.38 | 985.28 | 764.12 |

TABLE 13

| | Light Box Mean Glass | Above/Below Water | |
|---|---|---|---|
| Sample | Score | Level | Heating Coil |
| 72 | 23536.75 | Clean/Scale | Scale |
| 73 | N/A | Scale/Scale | Scale |
| 74 | 32525.54 | Clean/Clean | Scale |
| 75 | 40267.48 | Scale/Scale | Scale |
| 76 | 28681.75 | Scale/Scale | Scale |
| 77 | 49865.12 | Scale/Scale | Scale |

The results provided in Table 13 indicate that Samples 72, 74 and 76 had average light scores of less than 35,000. A visual inspection of the dishwashing machine after the test showed that the machine exhibit some scale above and/or below the water line for most of the Samples with scaling on the heating coil.

Although the present invention has been described with reference to preferred embodiments, workers skilled in the art will recognize that changes may be made in form and detail without departing from the spirit and scope of the invention.

1. A detergent composition comprising:
1 to 10 weight percent of at least one copolymer comprising 2-Acrylamido-2-methylpropane sulfonic acid or derivatives thereof;
at least one maleic acid polymer; and
at least one alkaline source, wherein the detergent composition is free of phosphorus.

2. The detergent composition of claim 1 wherein a weight ratio of copolymer to maleic acid polymer is from about 1:10 to about 10:1.

3. The detergent composition of claim 1 wherein the copolymer comprises a polycarboxylic acid/2-Acrylamido-2-methylpropane sulfonic acid copolymer.

4. The detergent composition of claim 1 wherein the copolymer comprises an acrylic acid/2-Acrylamido-2-methylpropane sulfonic acid copolymer.

5. The detergent composition of claim 1 wherein the maleic acid polymer comprises a maleic acid homopolymer.

6. The detergent composition of claim 1 further comprising at least one weak complexing agent.

7. The detergent composition of claim 6 wherein the weak complexing agent comprises an acid or a salt of an acid.

8. The detergent composition of claim 6 wherein the weak complexing agent comprises citric acid or a citrate salt.

9. The detergent composition of claim 6 wherein the weak complexing agent comprises tartaric acid or a tartrate salt.

10. The detergent composition of claim 6 wherein the weak complexing agent comprises sodium citrate.

11. The detergent composition of claim 1 wherein the alkaline source comprises a metal hydroxide, a metal carbonate or a combination.

12. The detergent composition of claim 1 wherein the alkaline source comprises sodium carbonate or bicarbonate.

13. The detergent composition of claim 1 wherein the alkaline source comprises sodium hydroxide.

14. The detergent composition of claim 1 further comprising at least one surfactant.

15. The detergent composition of claim 1 wherein the composition comprises from about 1.0 to about 10 wt % copolymer, from about 1.0 to about 25.0 wt % maleic acid polymer, from about 1.0 to about 60.0 wt % alkaline source and from about 1.0 to about 25.0 wt % of at least one acid or salt thereof.

16. The detergent composition of claim 1 wherein the composition is a solid and is free of a disintegrant.

17. A use solution comprising:
1 to 10 weight percent of at least one copolymer comprising 2-Acrylamido-2-methylpropane sulfonic acid or derivatives thereof;
at least one maleic acid polymer;
at least one alkaline source; and
water, wherein the detergent composition is free of phosphorus.

18. The use solution of claim 16 further comprising at least one weak complexing agent comprising an acid or a salt thereof.

19. The use solution of claim 17 wherein the at least one weak complexing agent comprises citric acid or a citrate.

20. A method of preventing scale in an automatic washing machine comprising:
during a washing cycle dispensing a detergent composition into the washing machine, the detergent composition comprising:
1 to 10 weight percent of at least one copolymer comprising 2-Acrylamido-2-methylpropane sulfonic acid or derivatives thereof;
at least one maleic acid polymer; and
at least one alkaline source, wherein the detergent composition is free of phosphorus.

21. The method of claim 19 wherein the detergent composition further comprises at least one weak complexing agent comprising an acid.
